(19) United States
(12) Patent Application Publication
(10) Pub. No.: US 2009/0165507 A1
(43) Pub. Date: Jul. 2, 2009

(54) Self assemblage combination lock comprising one set or multiple sets of combination ring

(76) Inventors: Kun Yuan Tong, Suwanee, GA (US); David Tong, Atlanta, GA (US)

Correspondence Address: Kun Yuan Tong, 2842 Lowe Court, Suwanee, GA, 30024, US

(21) Appl. No.: 12/005,587

(22) Filed: Dec. 27, 2007

(51) Int. Cl. E05B 37/02

(52) U.S. Cl. 70/25

(57) ABSTRACT

A self assemblage combination lock comprising one set or multiple sets of combination ring consists of a combination lock with one set or multiple sets of locking device. Its locking device has dual function of locking. The main function is to lock something and the other function is to lock itself and it is locked. It is disassemble and reassemble by its user. User can disassemble it and changes the sequence of combination rings or replaces the existing combination ring with his/her favorite combination with letters of alphabet or number. The self assemblage combination lock comprising one set or multiple sets of combination ring locks itself when the lock is locked and unlock itself when the lock is unlocked. Therefore it is disassemble and reassemble.

### THE BACKGROUND OF THE INVENTION

A combination lock has only one set of combination ring and its combination is fixed. A self assemblage combination lock comprising one set or multiple sets of combination ring has one set or multiple sets of combination ring and its combination can be changed by its user.

### THE BRIEF DESCRIPTION OF THE INVENTION

The combination of a self assemblage combination lock comprising one set or multiple sets of combination ring is changeable. User can disassemble it and reassemble it with one new set or multiple new sets of his/her favorite combination ring.

### THE DETAILED DESCRIPTION OF THE DRAWINGS

FIG. 1 is a perspective view of a self assemblage combination lock comprising one set of combination ring.

FIG. 2 is a dissection view of a self assemblage combination lock comprising one set of combination ring.

FIG. 3 is a perspective view of every part of a self assemblage combination lock comprising one set of combination ring.

FIG. 4 is a perspective view of a self assemblage combination lock comprising two sets of combination ring.

FIG. 5 is a dissection view of a self assemblage combination lock comprising two sets of combination ring.

FIG. 6 is a perspective view of every part of a self assemblage combination lock comprising two sets of combination ring.

FIG. 7 is a perspective view of every part of a self assemblage combination lock comprising three sets of combination ring.

FIG. 8 is a perspective view of every part of a self assemblage combination lock comprising four sets of combination ring.

FIG. 9 is a perspective view of a self assemblage combination lock comprising three sets of combination ring and a dissection view of its lock body and its threaded locking cap.

FIG. 10 is a perspective view of a self assemblage combination lock comprising four sets of combination ring and a dissection view of its lock body and its threaded locking cap.

### THE DETAILED DESCRIPTION OF THE INVENTION

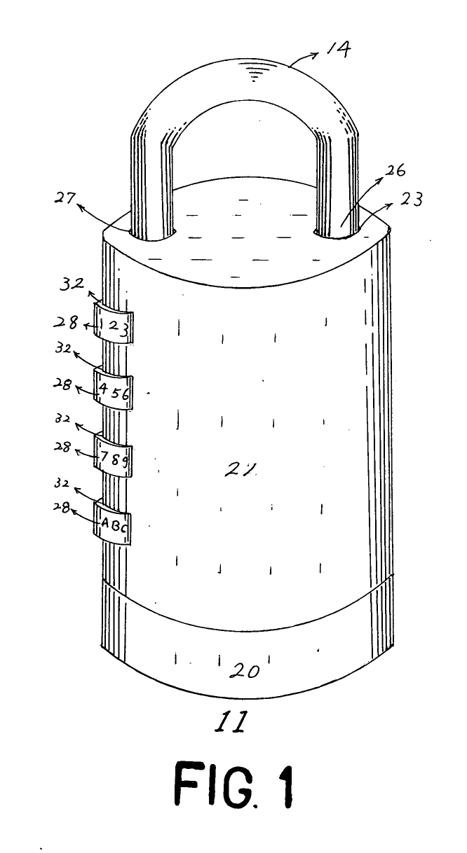

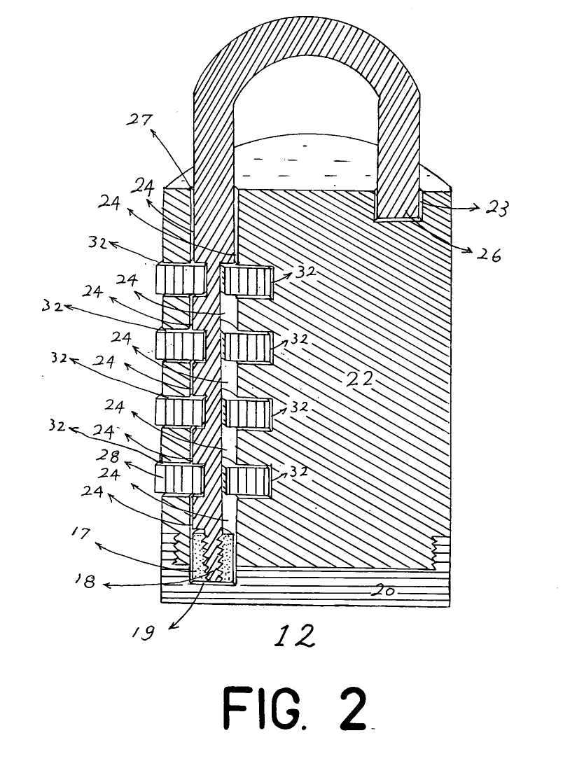

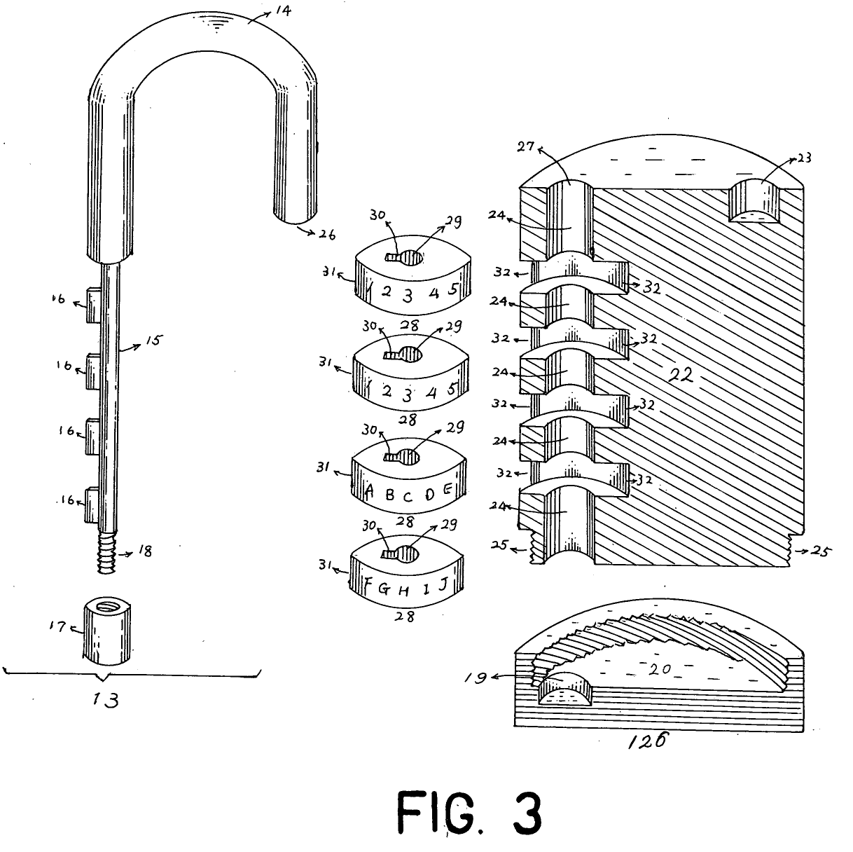

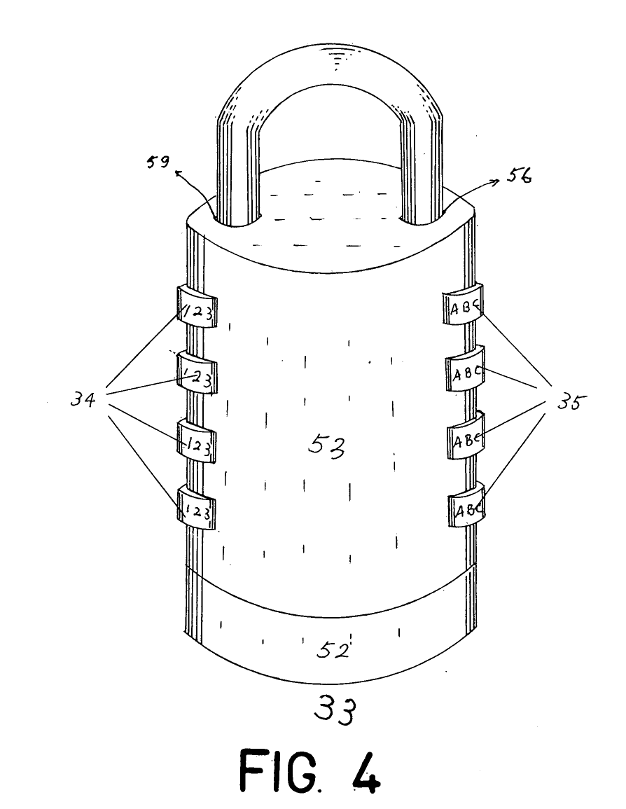

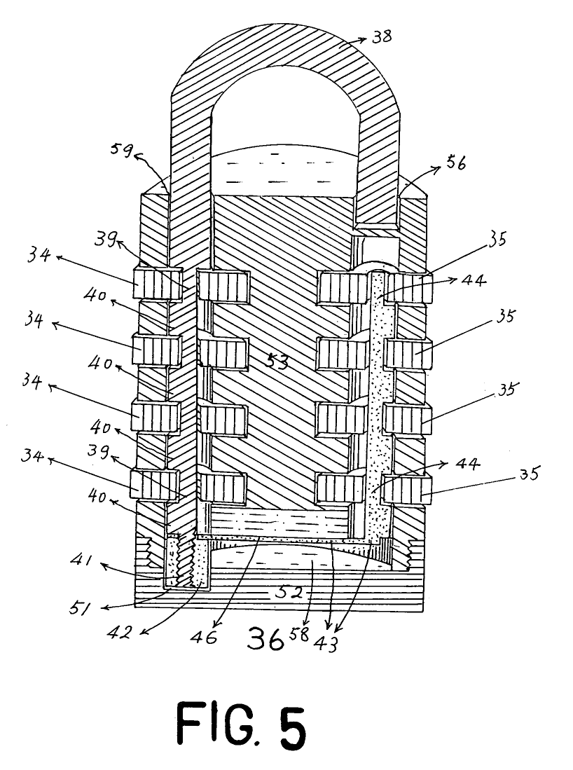

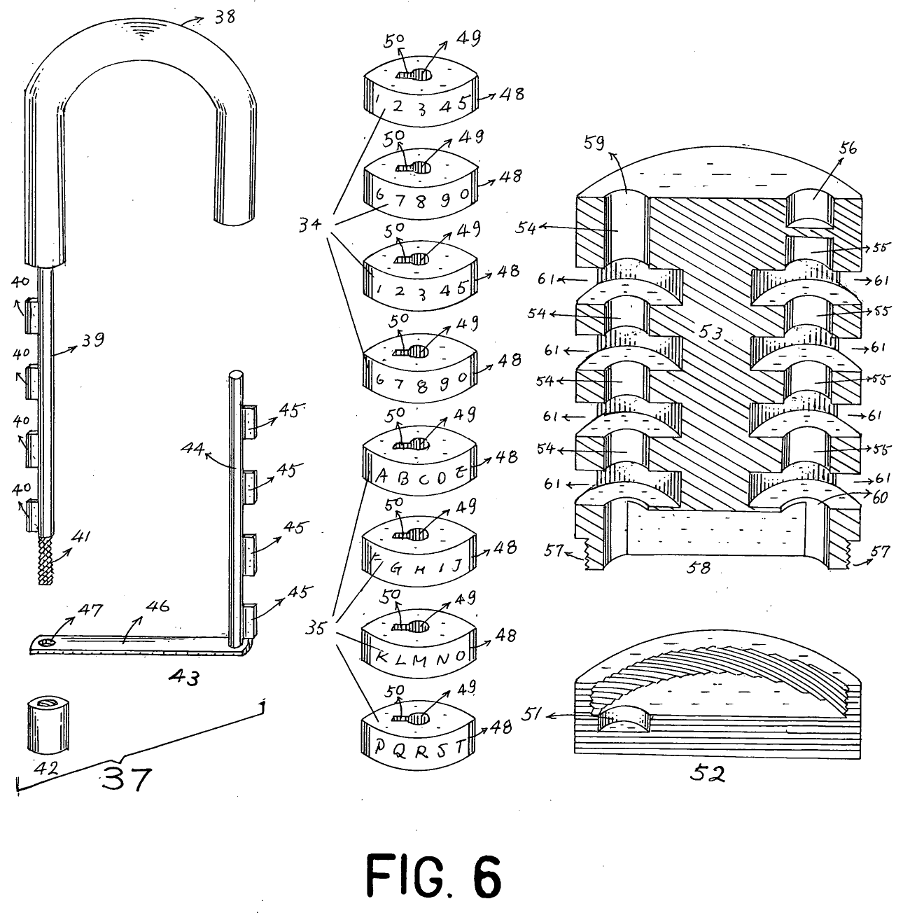

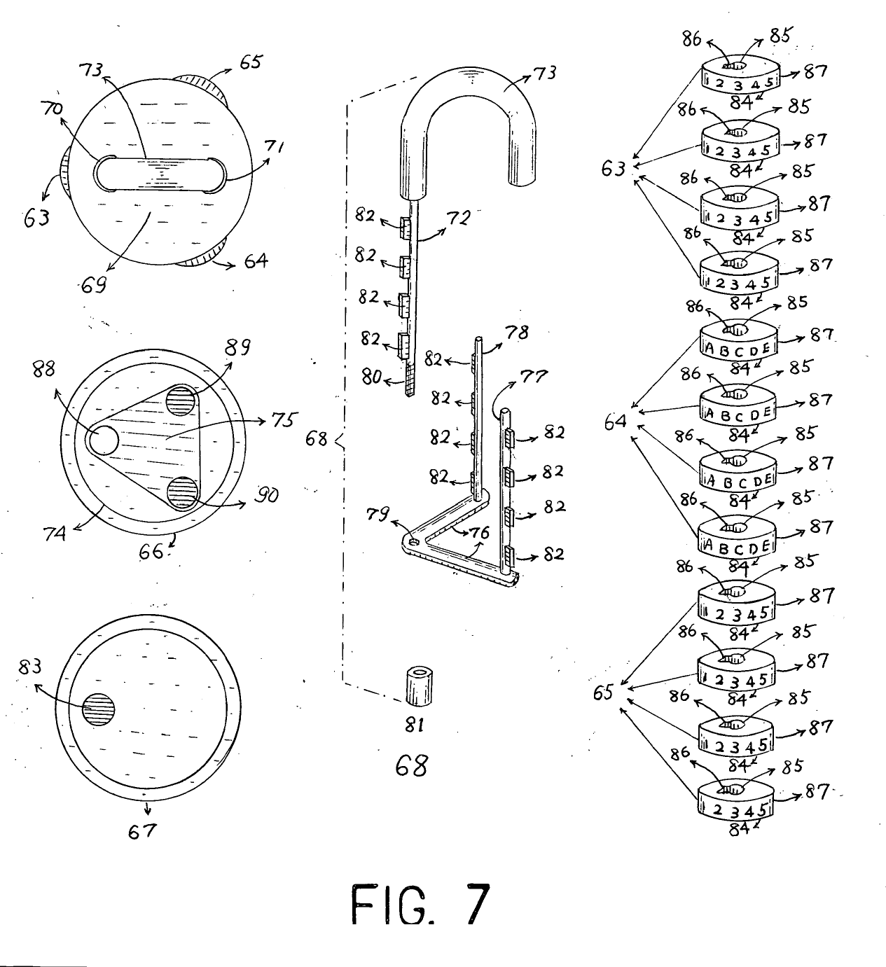

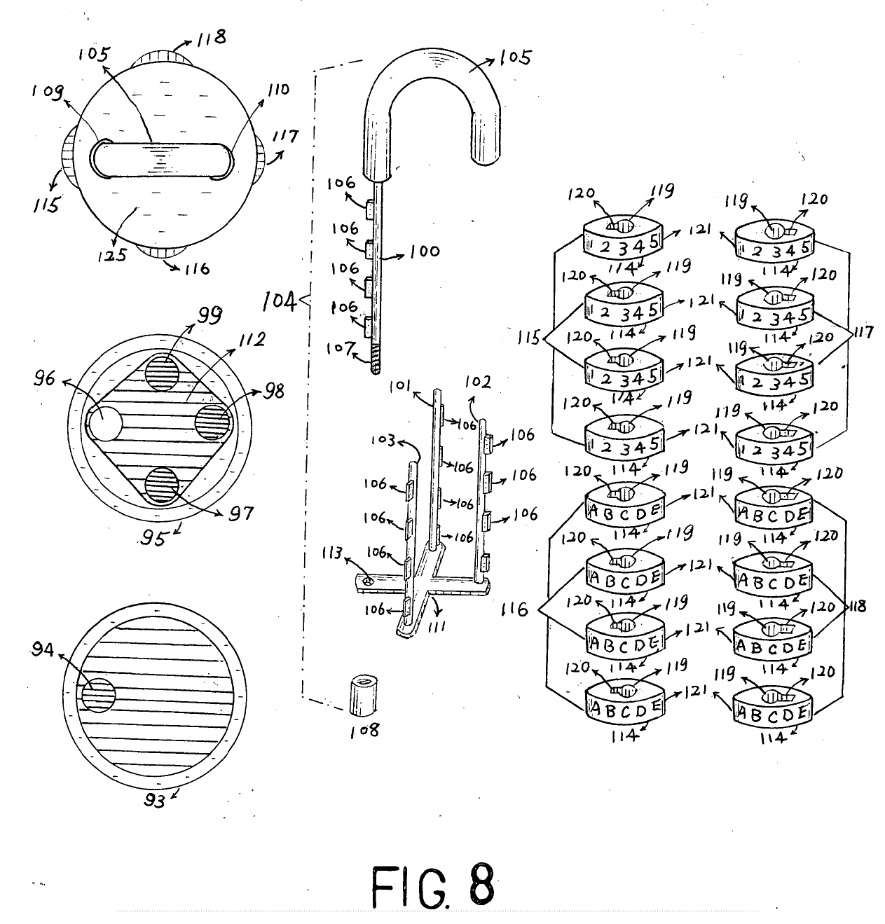

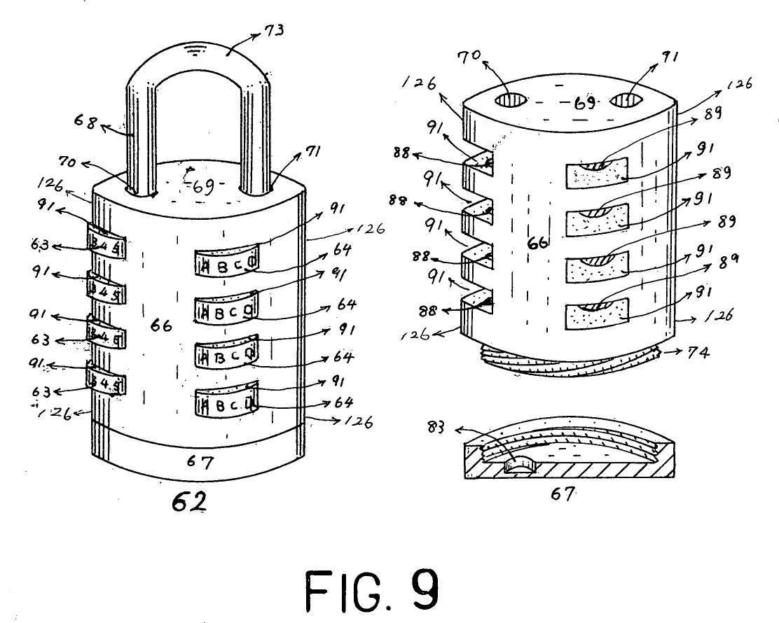

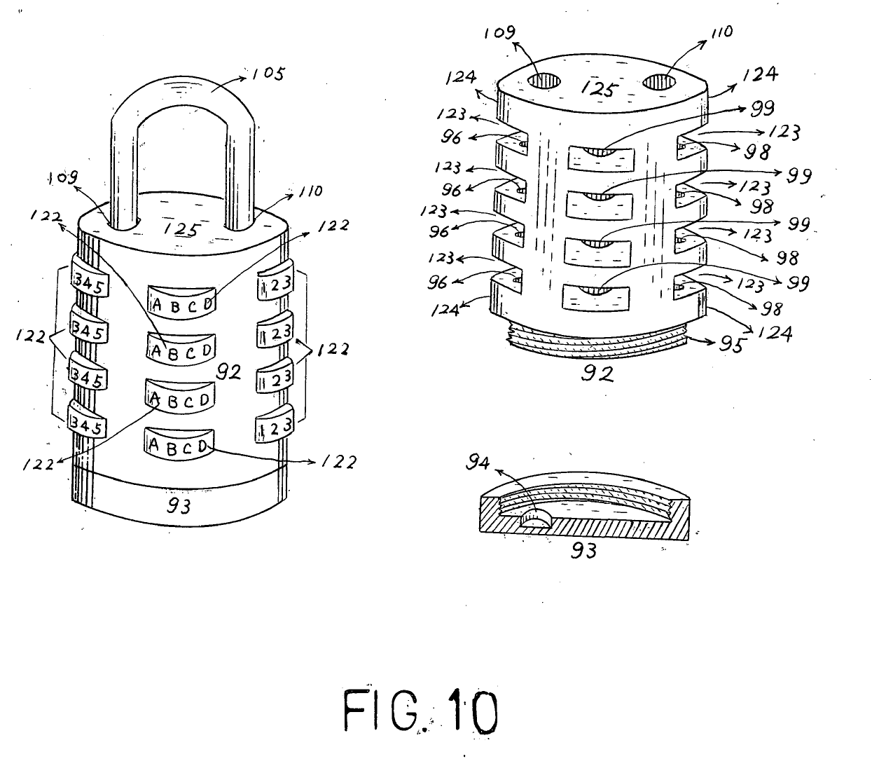

Referring now in detail to the drawing numeral 11 of FIG. 1 is a self assemblage combination lock comprising one set of combination ring. Numeral 12 of FIG. 2 is a dissection view of a self assemblage combination lock comprising one set of combination ring 11. Numeral 13 of FIG. 3 is a lock stem that consists of a curved hook 14, a lock rod 15, four (more or less) lock nodes 16, a threaded end 18 and a threaded nut 17. Threaded nut 17 is screwed onto the threaded end 18 of lock rod 15 and can be pushed down into lock hole 19 of threaded locking cap 20 of FIG. 3 to lock it. Numeral 126 of FIG.3 is the dissection view of threaded locking cap 20. Numeral 21 of FIG. 1 is lock body of a self assemblage combination lock comprising one set of combination ring 11 and numeral 22 of FIG. 2 and 3 is its dissection view. Lock body 21 has a main lock hole 23, a upper hole 27, a canal 24, four (more or less but equal to the number of lock node 16) combination slots and a threaded end 25 as illustrated in FIGS. 2 and 3. The upper end 26 of lock stem 13 inserts into the main lock hole 23 as illustrated in FIGS. 2 and 3. The lock rod 15 of lock stem 13 inserts into the canal 24 from its upper hole 27 as illustrated in FIGS. 2 and 3. Numeral 28 of FIG. 3 is combination ring that has a central hole 29, a side hole 30 and a side wall 31. Each combination ring 28 has engraved letters of alphabet or numbers on its side wall 31 as illustrated in FIG. 3. The side holes 30 allow lock nodes 16 to pass through. After all the side holes 30 line up and align with lock nodes 16 the lock stem 13 can be pulled up and down. After the threaded nut 17 of FIGS. 2 and 3 screws onto threaded end 18 of lock rod 15 the threaded nut 17 and the lock rod 15 are stopped by the lowest combination ring 28 when lock stem 13 is pulled up. Numeral 32 of FIGS. 2 and 3 is combination ring slot that each admits comfortably one combination ring 28. When a self assemblage combination lock comprising one set of combination ring 11 is locked the threaded nut 17 and the threaded end 18 of lock stem 13 sink into lock hole 19 of the threaded locking cap 20 to lock it as illustrated in FIG. 2. When to disassemble a self assemblage combination lock comprising one set of combination ring 11 user first aligns side hole 30 of combination ring 28 with lock nodes 16 and pulls up lock stem 13 to pull threaded nut 18 out of lock hole 19. Secondly user unscrews the threaded locking cap 20 out of threaded end 25 of lock body 21. Thirdly user unscrews threaded nut 17 out of threaded end 18 of lock rod 15. Fourthly user pulls lock stem 13 upward to remove it out of lock body 21. Fifthly user dislodges combination rings 28 out of combination ring slot 32. When to assemble the combination loc comprising one set combination ring 11 user first inserts combination rings 28 with his/her favorite letter of alphabet or number if plenty of combination rings are available into combination slot 32. Secondly user aligns the side hole 30 of combination ring 28 with lock nodes 16 of lock rod 15. Thirdly user inserts lock rod 15 into canal 24 of lock body 21 and central hole 29 of combination ring 28 from upper hole 27. Fourthly user screws threaded nut 17 onto threaded end 18 of lock rod 15. And finally user screws threaded locking cap 20 onto threaded end 25 of lock body 21 to place the lock hole 19 of threaded locking cap 20 just under threaded nut 17 and threaded end 18 of lock rod 15. The number of combination ring slot 32 is equal to that of lock nodes 16 of lock rod 15 and is also equal to that of combination ring 28. Numeral 33 of FIG. 4 is a self assemblage combination lock comprising two sets of combination rings 34 and 35. Numeral 36 of FIG. 5 is the dissection view of a self assemblage combination lock comprising two sets of combination rings 33. Numeral 37 of FIG. 6 is a lock stem that comprises a curved hook 38, a lock rod 39 that has four (more or less) lock nodes 40 and a threaded end 41, a threaded nut 42 and an attachable L-shaped lock plate 43. The attachable L-shaped lock plate 43 of FIGS. 5 and 6 comprises a connecting base plate 46 that has a side hole 47 at one end and a lock rod 44 that is installed vertically at the other end of connecting base plate 46. Lock rod 44 has four (or more) lock nodes 45 on it. After hole 47 of connecting base plate 46 passes through the threaded end 41 of lock rod 39 the threaded nut 42 screws onto the threaded end 41 to connect and to fix L-shaped lock plate 43 onto lock rod 39 as illustrated in FIG. 5. The combination rings 34 and 35 of FIGS. 5 and 6 has a side wall 48 that has engraved letter of alphabet or numbers, a central hole 49 and a side hole 50. When a self assemblage combination lock comprising two sets of combination ring 33 is locked the threaded nut 42 and the threaded end 41 of lock rod 39 sink into lock hole 51 of the threaded locking cap 52 to lock it as illustrated in FIG. 5. Numeral 53 of FIG. 4, 5 and 6 is the lock body of a combination lock comprising two sets of combination ring 33. Lock body 53 has two canals 54 and 55, four (more or less but equal to the number of lock nodes 44 or 45) combination ring slots at each side, one upper hole 59 of canal 54 at one side, one main lock hole 56 at the other side and a threaded bottom end 57 as illustrated in FIGS. 4, 5 and 6. Numeral 54 of FIG. 6 is a canal to admit lock rod 39 of lock stem 37 from its upper hole 59. Numeral 55 of FIG. 6 is a canal to admit lock rod 44 of L-shaped lock plate 43 from its opening 60 below. Canal 55 is made beneath main lock hole 56 through the lock body 53 or not. Numeral 56 of FIGS. 4, 5 and 6 is main lock hole of lock body 53 to insert curved hook 38. Numeral 57 of FIG. 6 is the threaded bottom end of lock body 53 to catch threaded locking cap 52. There is a roomy space 58 inside the threaded end 57 to admit comfortably the connecting base plate 46 of attachable L-shaped lock plate 43 as illustrated in FIGS. 5 and 6. Numeral 59 of FIGS. 4, 5 and 6 is the upper hole of canal 54. Numeral 60 of FIG. 6 is the opening of canal 55. Numeral 61 of FIG. 6 is the combination ring slot that admits combination ring 34 and 35. When to disassemble a self assemblage combination lock comprising two sets of combination ring 33 user first aligns side hole 50 of combination ring 34 and 35 with lock nodes 40 of lock rod 39 and lock nodes 45 of lock rod 44. Secondly user pulls up lock stem 37 to pull up the threaded nut 42 and threaded end 41 of lock rod 39 out of the lock hole 51 of threaded locking cap 52. Thirdly user unscrews the threaded locking cap 52 to remove it out of threaded end 57 of lock body 53. Fourthly user unscrews threaded nut 42 out of threaded end 41 of lock rod 39. Fifthly user pulls out lock rod 39 from above and attachable L-shaped lock plate 43 from below. Sixthly user dislodges combination ring 34 and 35 from combination slot 61. When to assemble the combination lock comprising two set of combination ring 33 first user selects his/her favorite combination rings 34 and 35 of FIG. 4, 5. Secondly user inserts the selected combination rings 34 and 35 into combination slots 61 by his/her favorite sequence. Thirdly user aligns side hole 50 of combination ring 34 and 35 with lock nodes 40 and 45. Fourthly user inserts lock rod 39 from upper hole 59 above into canal 54 and central hole 49 of combination ring 34. Fifthly user inserts lock rod 44 of attachable L-shaped lock plate 43 from opening 60 below into canal 55 and central hole 49 of combination ring 35. Sixthly user screws threaded nut of 42 onto threaded end 41 of lock rod 39 to connect and to fix attachable L-shaped lock plate 43 to lock rod 39. And finally user screws threaded locking cap 52 onto threaded end 57 of lock body 53 to position lock hole 51 under threaded nut 42 and threaded end 41. Numeral 62 of FIG. 9 is a self assemblage combination lock comprising three sets of combination rings 63, 64 and 65 that is shown in FIG. 7. The combination ring 63, 64 and 65 has different engraved letters of alphabet or numbers as illustrated in FIG. 7. A self assemblage combination lock comprising three sets of combination ring 62 of FIGS. 7 and 9 comprises a lock body 66, a threaded locking cap 67, a lock stem 68 and numerous combination rings 63, 64 and 65. Lock body 66 of FIG. has two holes 70 and 71 on the top surface 69, three canals 88, 89 and 90, three rows of combination ring slot 91 on the side wall 126 and one threaded bottom end 74 as illustrated in FIGS. 7 and 9. Hole 70 is the upper opening of canal 88 that is made through the entire length of lock body 66. Hole 71 is the main lock hole to be inserted by curved hook 73 of lock stem 68. Canals 89 and 90 of FIGS. 7 and 9 are made not through the lock body 66 but higher than the top of the highest combination ring slot 91 to contain lock rods 77 and 78. Numeral Lock stem 68 of FIG. 7 consists of a curved hook 73, three lock rods 72, 77 and 78 a threaded nut 81 and a V-shaped connecting base plate 76. The V-shaped connecting base plate 76 installs vertically two lock rods 77 and 78, one at each end, and has a central hole 79 at its apex. The top surface 69 of lock body 66 of FIGS. 7 and 9 has two holes 70 and 71 to admit respectively lock rod 72 and curved hook 73. Numeral 74 of FIGS. 7 and 9 is the threaded bottom end of lock body 66. Inside the threaded bottom end 74 of body 66 of FIGS. 7 and 9 there is a roomy space 75 to admit comfortably the V-shaped connecting base plate 76. After the central hole 79 of V-shaped connecting base plate 76 passes through threaded end 80 the threaded nut 81 of FIG. 7 screws onto the threaded end 80 of lock rod 72 to connect and to fix V-shaped connecting base plate 76 to lock rod 72. Lock rods 72, 77 and 78 have installed four (more or less but equals to the number of combination slot 91) lock nodes 82. The threaded locking cap 67 of FIGS. 7 and 9 has a lock hole 83 to admit comfortably the threaded nut 81 and the threaded end 80 of lock rod 72. Each combination ring 84 of three sets of combination ring 63, 64 and 65 of FIGS. 7 and 9 has a central hole 85 to admit comfortably lock rods 72, 77 and 78, a side hole 86 to pass comfortably lock node 82 and a side wall 87 that has engraved letters of alphabet or number. Numeral 91 of FIG. 9 is combination ring slot to contain combination ring 84. The number of combination ring slot 91 is equal to that of the lock nodes 82 of each lock rod, 72, 77 and 78 and is also equal to that of combination ring 84. When to assemble a self assemblage combination lock comprising three sets of combination ring 62, first user inserts his/her favorite combination ring 84 into combination ring slots 91 of lock body 66 of FIG. 9. Secondly user lines up all side holes 86 of combination ring 63, 64 and 65 and aligns them with lock nodes 82 of lock rods 72, 77 and 78. Thirdly user inserts lock rod 72 of FIG. 7 into canal 88 from top hole 70 and into central hole 85 of combination ring 84. Fourthly user inserts two lock rods 77 and 78 respectively into canals 89 and 90 and into central hole 85 of combination ring 84 from below. Fifthly user passes central hole 79 of V-shaped connecting base plate 76 into threaded end 80 of lock rod 72 and screws threaded nut 81 onto threaded end 80 to connect and to fix V-shaped connecting base plate 76 to lock rod 72. And finally user screws threaded locking cap 67 onto threaded bottom end 74 of lock body 66 and to place the lock hole 83 just under threaded nut 81 and threaded end 80. When a self assemblage combination lock comprising three sets of combination ring 62 is locked the threaded nut 81 and threaded end 80 sink into lock hole 83 of the bottom threaded locking cap 67 to lock it. Numeral 122 of FIG. 10 is a self assemblage combination lock comprising four sets of combination ring. Numeral 92 of FIG. 10 is lock body of a self assemblage combination lock comprising four sets of combination ring 122. Lock body 92 of FIGS. 8 and 10 has a top opening 109 of canal 96 at one side of its top 125, one main lock hole 110 at the other side of its top 125, four vertical rows of combination ring slot 123 on the side wall 124, four canals 96, 97, 98 and 99 and one bottom threaded end 95. Canal 96 of FIGS. 8 and 10 is made through the entire length of lock body 92. Canal 97, 98 and 99 of FIGS. 8 and 10 are not made through the entire length of lock body 92 but at least higher than the top of the highest combination ring slot 123. Numeral 93 of FIGS. 8 and 10 is a threaded locking cap that has a lock hole 94 at inner side. The threaded locking cap 93 of FIGS. 8 and 10 screws onto the bottom threaded end 95 of lock body 92. Numeral 96, 97, 98 and 99 of FIGS. 8 and 10 are canals in lock body 92 to admit respectively lock rods 100, 101, 102 and 103. Lock stem 104 of FIG. 8 comprises a curved hook 105, four lock rods 100, 101, 102 and 103, a threaded nut 108 and a cross-shaped base plate 111. Lock rods 100, 101, 102 and 103 are equipped with four (or more but equal to the number of combination slot 123) lock nodes 106 as illustrated in FIG. 8. Lock rod 100 has a threaded end 107. Numeral 108 of FIG. 8 is a threaded nut that screws onto the threaded end 107 of lock rod 100. Numeral 109 of FIGS. 8 and 10 is the upper hole of canal 96. Lock rod 100 of lock stem 104 of FIG. 8 inserts into canal 96 of FIGS. 8 and 10 through the upper hole 109. Numeral 110 of FIGS. 8 and 10 is the main lock hole on the top 125 of lock body 92 to admit curved hook 105. Cross-shaped base plate 111 of FIG. 8 installs vertically three lock rods 101, 102 and 103 at the end of three of its four arms and has a side hole 113 at the end of the fourth arm. Numeral 112 of FIG. 8 is a roomy space inside the bottom threaded end 95 of lock body 92 to admit the cross shaped base plate 111 and to allow it move freely up and down. After side hole 113 of the cross-shaped base plate 111 passes through the threaded end 107 of lock rod 100 the threaded nut 108 screws onto threaded end 107 to connect and to fix the cross-shaped base plate 111 to lock rod 100. The unit of lock stem 104 that includes the cross-shaped base plate 111, four lock rods, 100, 101, 102, and 103, curved hook 105 and threaded nut 108 moves up and down simultaneously. Numeral 114 of FIG. 8 is the combination ring of four sets of combination ring 115, 116, 117 and 118. Each combination ring 114 of FIG. 8 has a central hole 119, a side hole 120 and a side wall 121. Each side wall 121 of combination ring 114 of FIG. 8 has engraved letters of alphabet or numbers. The central hole 119 of FIG. 8 admits comfortably lock rods 100, 101, 102 and 103. The side hole 120 of combination ring 114 of FIG. 8 admits lock node 106 of lock rods 100, 101, 102 and 103. Numeral 123 of FIG. 10 is the combination ring slot that is built on the side wall 124 of lock body 92. Each combination ring slot 123 admits one combination ring 114. The number of combination ring slot 123 is equal to that of lock nodes 106 of each lock rod, 100 or 101 or 102 or 103 and is also equal to that of combination ring 114. The way to assemble or to disassemble a self assemblage combination lock comprising four sets of combination ring 122 is like the way to assemble or to disassemble a self assemblage combination lock comprising two sets or three sets of combination ring, 33 or 62.

1. A self assemblage combination lock comprising a lock body, a lock hook, lock rod(s), combination rings, one or no base connector, and one removable threaded locking hole bottom cap.

2-13. (canceled)

14. A self assemblage combination lock of claim 1 wherein said lock body comprising a metal columnar block which has two canals on the top, 1 or 2 or 3 or 4 row(s) of semi-open circular slots on side wail, 1 or 2 or 3 or 4 concealed canal(s) and a threaded bottom end. Wherein said two canals located on top of said lock body, one at each side. Wherein said row(s) of semi-open circular slot located on the side wail of said lock body below its top and all the way down to said threaded bottom end with a separate distance which is between two said semi-open circular slots and equals to the height of said semi-open circular slot. Wherein said semi-open circular slot has portion exposed vertically outside of said side wall. The number of said semi-open circular slots in one row may vary. Wherein said concealed canal passes through the center of each row of said semi-open circular slot from the level which is about the height of said semi-open slot above the top one of said semi-open circular slot all the way down to said threaded bottom end of said lock body. The number of said concealed canals is equal to that of row(s) of said semi-open circular slots. One of said concealed canals connects one of said two canals on the top of said lock body.

15. A self assemblage combination lock of claim 1 where said lock hook is an U-shaped hook which has one visible free end which enters in and out of one of the said two canals on the top of lock body of claim 14 and one invisible concealed end which is located inside said concealed canal of lock body of claim 14 and connects one of said lock rod(s) of claim 1.

16. A self assemblage combination lock of claim 1 wherein said combination ring has a central key-hole shaped hole whose round hole is located at the center and rectangular hole by its side. Wherein said combination ring is stored in each of said semi-open circular slot of claim 14. The height of said combination ring is a little bit shorter than that of semi-open circular slot and the diameter of said combination ring is a little bit smaller than that of said semi-open circular slot.

17. A self assemblage combination lock of claim 1 wherein said lock rod(s) is rod(s) which has equipped with a couple of nodes and a threaded end with a nut. Wherein said nodes are aligned on one side of said rod with a separate distance of the height of one of said semi-open circular slots of claim 14. The number of said nodes is equal to that of said semi-open circular slots in a row of claim 14. The number of said lock rod(s) is equal to that of said row(s) of said semi-open circular slot of claim 14. The height, width and length of said nodes are a little bit smaller those of said central key-hole shaped hole of claim 16. Wherein said node can pass snugly through said rectangular hole of claim 16. The distance from the top of one said node to the top of next said node is equal to the height of one of said semi-open circular slot of claim 14. The length of said rod above said threaded end is equal to that of said concealed canal of claim 14 except one long rod which connects said concealed end of said U-shaped hook of claim 15. Wherein said long rod is about twice the length of said threaded end longer than the rest of said rod(s) and can almost reach said removable threaded locking hole bottom cap of claim 1 when said combination lock of claim 1 is locked.

18. A self assemblage combination lock of claim 1 wherein said base connecter is an I-shaped plate or a V-shaped plate or a cross-shaped plate which has a hole at each end. Wherein said I-shaped plate is for said lock body of claim 14 which has two rows of said semi-open circular slots. Wherein said V-shaped plate is for said lock body of claim 14 which has three rows of said semi-open circular slots. Wherein said cross-shaped plate is for said lock body of claim 14 which has four rows of said semi-open circular slots. Wherein said hole at each end of said base connecter admits said threaded end of said rod of claim 17. Wherein said base connecter connects ail said rods of claims 1 and 17 at the said threaded end of each said rod of claim 17 and fastens them with said nuts of claim 17. Wherein said base connecter is located below said threaded bottom end of said lock body of claim 14.

19. A self assemblage combination lock of claim 1 wherein said removable threaded locking hole bottom cap comprising a threaded bottom cap and one locking hole. Wherein said locking hole is located at one side of inside of said threaded bottom cap and can admit said nut and threaded end of said long rod of claim 17. Wherein said locking hole is positioned right under said long rod of claim 17 when said removable threaded locking hole bottom cap is screwed tightly onto said threaded end of said lock body of claim 14. There is a roomy space between said threaded bottom end of lock body of claim 14 and said removable threaded locking hole bottom cap to store said base connecter of claim 18.
